(19) United States
(12) Patent Application Publication
(10) Pub. No.: US 2008/0001809 A1
(43) Pub. Date: Jan. 3, 2008

(54) DETECTING SIGNAL INTERFERENCE IN A VEHICLE SYSTEM

(76) Inventors: Walter Gordon Woodington, Lincoln, MA (US); Dennis Hunt, Westford, MA (US); Edward Sternal, Tyngsboro, MA (US); Kenneth A. Booth, Nashua, NH (US)

Correspondence Address: VALEO RAYTHEON SYSTEMS, INC.;c/o DALY, CROWLEY, MOFFORD AND DURKEE, LLP, 354A TURNPIKE STREET, SUITE 301-A, CANTON, MA, 02021-2714, US

(21) Appl. No.: 11/427,829

(22) Filed: Jun. 30, 2006

(51) Int. Cl. G01S 13/93

(52) U.S. Cl. 342/70

(57) ABSTRACT

In one aspect, the invention is a method, which includes detecting interference in a vehicle system disposed in a vehicle. Detecting includes measuring a frequency of a signal provided from a power source used in the vehicle. Detecting also includes determining if the signal has a frequency within a frequency band used by the vehicle system.

### CROSS-REFERENCE WITH OTHER PATENT APPLICATIONS

This patent application includes aspects from the following patent applications which are subject to an obligation of assignment to the same entity as this patent application and are incorporated herein by reference in their entirety: U.S. patent application Ser. No. 11/323,960, filed Dec. 30, 2005 and entitled “GENERATING EVENT SIGNALS IN A RADAR SYSTEM”; U.S. patent application Ser. No. 11/323,459, filed Dec. 30, 2005 and entitled “MULTI-STAGE FINITE IMPULSE RESPONSE FILTER PROCESSING”; U.S. patent application Ser. No. 11/323,458, filed Dec. 30, 2005 and entitled “MULTICHANNEL PROCESSING OF SIGNALS IN A RADAR SYSTEM”; U.S. patent application Ser. No. 11/324,035, filed Dec. 30, 2005 and entitled “VEHICLE RADAR SYSTEM HAVING MULTIPLE OPERATING MODES”; U.S. patent application Ser. No. 11/322,664, filed Dec. 30, 2005 and entitled “REDUCING UNDESIRABLE COUPLING OF SIGNAL(S) BETWEEN TWO OR MORE SIGNAL PATHS IN A RADAR SYSTEM”; and U.S. patent application Ser. No. 11/322,684, filed Dec. 30, 2005 and entitled “SYSTEM AND METHOD FOR GENERATING A RADAR DETECTION THRESHOLD”.

### TECHNICAL FIELD

The invention relates to vehicle systems, and more particularly, to detecting signal interference in a vehicle system.

### BACKGROUND

Radar systems have been developed for various applications associated with vehicles, such as automobiles, trucks and boats. A radar system mounted on a vehicle detects the presence of objects including other vehicles in proximity to the vehicle. Such a vehicle radar system may be used in conjunction with a braking system of the vehicle to provide active collision avoidance or in conjunction with a cruise control system of the vehicle to provide intelligent speed and traffic spacing control. In a further application, the vehicle radar system provides a passive indication of obstacles to a driver of the vehicle on a display, and in particular, detects objects in a blind spot of the vehicle.

### SUMMARY

In one aspect, the invention is a method, which includes detecting interference in a vehicle system disposed in a vehicle. Detecting includes measuring a frequency of a signal provided from a power source used in the vehicle. Detecting also includes determining if the signal has a frequency within a frequency band used by the vehicle system.

In another aspect, the invention is an article, which includes a machine-readable medium that stores executable instructions. The instructions cause a machine to detect interference in a vehicle system. The instructions causing a machine to detect include instructions causing a machine to measure a frequency of a signal provided from a power source providing power to a component of the vehicle system and to determine if the signal has a frequency within a frequency band used by the vehicle system.

In a further aspect, the invention is an apparatus which includes circuitry to detect interference in a vehicle system. The circuitry to detect includes circuitry to measure a frequency of a signal provided from a power source providing power to a component of the vehicle system and to determine if the signal has a frequency within a frequency band used by the vehicle system.

### DESCRIPTION OF THE DRAWINGS

FIG. 1 is a diagrammatic view of a pair of vehicles traveling along a roadway.

FIG. 2 is a block diagram of a vehicle system architecture.

FIG. 3 is a block diagram of a vehicle radar system.

FIG. 4 is a block diagram of a receiver.

FIG. 5 is a graph of voltage-over-time for a power source.

FIG. 6 is a flowchart for a process for detecting interference in a vehicle system.

FIG. 7 is a block diagram of a computer system on which the process of FIG. 6 may be implemented.

### DETAILED DESCRIPTION

It is a desire of vehicle radar systems to provide accurate and reliable detection of objects with minimal influence from interfering signals. The objects may correspond to moving objects (e.g., moving vehicles) or stationary objects (e.g., parked vehicles). Characteristics of the vehicle radar system that contribute to accuracy and reliability include susceptibility of the system to interfering signals (including noise signals), and the overall precision with which received radio frequency (RF) signals are processed in the presence of the noise and other interfering signals to detect objects. Susceptibility to interfering signals may cause the vehicle radar system to falsely detect an object (i.e., to raise a false alarm rate), and/or, may cause the vehicle radar system to miss a detection of an object (i.e., to have a reduced probability of detection). Described herein is a novel approach for detecting interference signals in a vehicle system including interference signals caused by changes in a power source (e.g., a battery, an alternator, a transformer and so forth) disposed in a vehicle, for example.

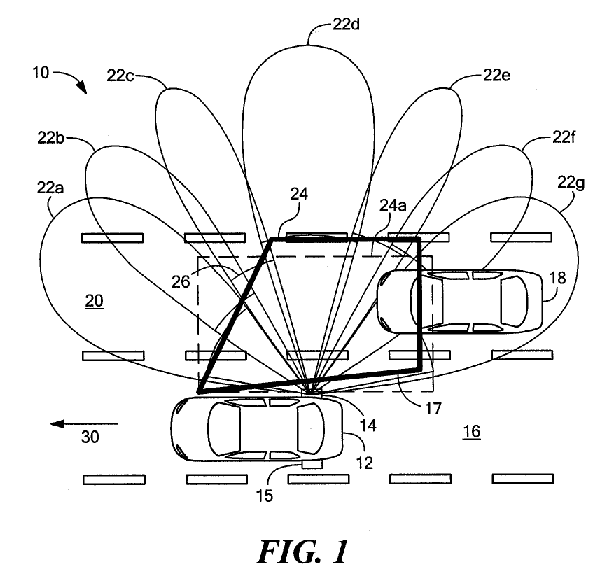

Referring to FIG. 1, a first vehicle 12 traveling in a first traffic lane 16 of a road includes a side-object detection (SOD) system 14. The SOD system 14 is disposed on a side portion of the vehicle 12 and in particular, the SOD system 14 is disposed on a right rear quarter of the vehicle 14. The vehicle 12 also includes a second SOD system 15 disposed on a side portion of a left rear quarter of the vehicle 12. The SOD systems 14, 15 may be coupled to the vehicle 12 in a variety of ways. In some embodiments, the SOD systems may be coupled to the vehicle 12 as described in U.S. Pat. No. 6,489,927, issued Dec. 3, 2002, which is incorporated herein by reference in its entirety. A second vehicle 18 travels in a second traffic lane 20 adjacent the first traffic lane 16. The first and second vehicles 12, 18 are both traveling in a direction 30 and in the respective first and second traffic lanes 16, 20.

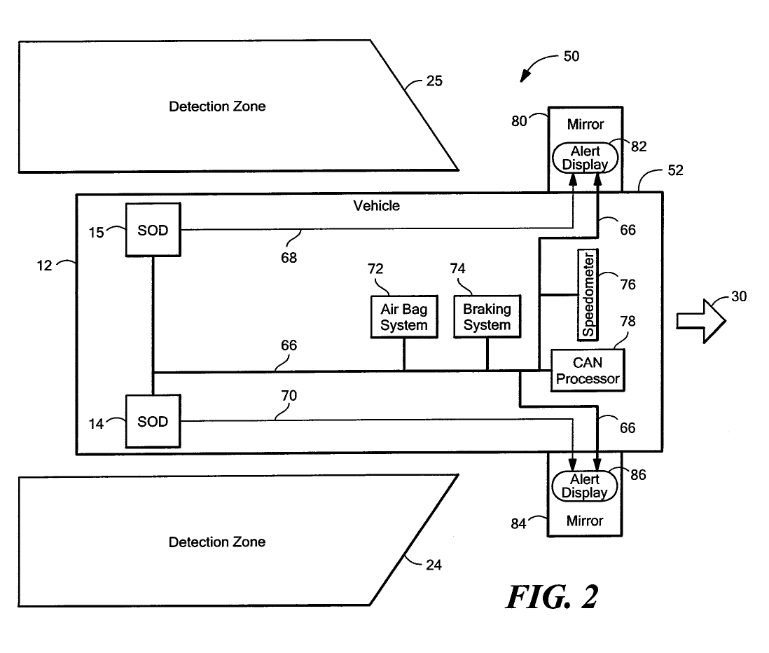

The second vehicle 18 may be traveling slower than, faster than, or at the same speed as the first vehicle 12. With the relative position of the vehicles 12, 18 shown in FIG. 1, the second vehicle 18 is positioned in a “blind spot” of the first vehicle 12. The blind spot is an area located on a side of the first vehicle 12 whereby an operator of the first vehicle 12 is unable to see the second vehicle 18 either through side-view mirrors 84, 86 (see FIG. 2) or a rear-view mirror (not shown) of the first vehicle 12.

The SOD system 14 generates multiple receive beams (e.g., a receive beam 22a, a receive beam 22b, a receive beam 22c, a receive beam 22d, a receive beam 22e, a receive beam 22f and a receive beam 22g) and an associated detection zone 24. The detection zone 24 is formed by the SOD system 14 by way of maximum detection ranges associated with each one of the receive beams 22a-22g, for example, the maximum detection range 26 associated with the receive beam 22c. Each of the receive beams 22a-22g may also have a minimum detection range (not shown), forming an edge 17 of the detection zone 24 closest to the first vehicle.

In one particular embodiment, the SOD system 14 is a frequency modulated continuous wave (FMCW) radar, which transmits continuous wave chirp radar signals, and which processes received radar signals accordingly. In some embodiments, the SOD system 14 may be of a type described, for example, in U.S. Pat. No. 6,577,269, issued Jun. 10, 2003; U.S. Pat. No. 6,683,557, issued Jan. 27, 2004; U.S. Pat. No. 6,642,908, issued Nov. 4, 2003; U.S. Pat. No. 6,501,415, issued Dec. 31, 2002; and U.S. Pat. No. 6,492,949, issued Dec. 10, 2002, which are all incorporated herein by reference in their entirety.

In operation, the SOD system 14 transmits an RF signal having portions which impinge upon and are reflected from the second vehicle 18. The reflected signals (also referred to as “echo” signals) are received in one or more of the receive beams 22a-22g. Other ones of the radar beams 22a-22g, which do not receive the echo signal from the second vehicle 18, receive and/or generate other radar signals, for example, noise signals. As used herein, the term “noise signal” is used to describe a signal comprised of one or more of a thermal noise signal, a quantization noise signal, a crosstalk signal (also referred to as leakage or feed through signal), and an ambient RF noise signal.

In some embodiments, the SOD system 14 may transmit RF energy in a single broad transmit beam (not shown). In other embodiments, the SOD system 14 may transmit RF energy in multiple transmit beams (not shown), for example, in seven transmit beams associated with the receive beams 22a-22g.

In operation, the SOD system 14 may process the received radar signals associated with each one of the receive beams 22a-22g in sequence, in parallel, or in any other time sequence. The SOD system 14 may be adapted to identify an echo radar signal associated with the second vehicle 18 when any portion of the second vehicle 18 is within the detection zone 24. Therefore, the SOD system 14 is adapted to detect the second vehicle 18 when at least a portion of the second vehicle is in or near the blind spot of the first vehicle 12.

Referring to FIG. 2, an exemplary vehicle system 50 which may be the same as or similar to the vehicle systems included in vehicles 12, 18 described above in conjunction with FIG. 1, includes vehicle systems such as SOD systems 14, 15, an air bag system 72, a braking system 74, and a speedometer 76.

Each one of the SOD systems 14, 15 is coupled to a CAN processor 78 through a Controller Area Network (CAN) bus 66. As used herein, the term “controller area network” is used to describe a control bus and associated control processor typically found in vehicles. For example, the CAN bus and associated CAN processor may control a variety of different vehicle functions such as anti-lock brake functions, air bags functions and certain display functions.

The vehicle 12 includes two side-view mirrors 80, 84, each having an alert display 82, 86, respectively, viewable therein. Each one of the alert displays 82, 86 is adapted to provide a visual alert to an operator of a vehicle in which system 50 is disposed (e.g., vehicle 12 in FIG. 1) to indicate the presence of another vehicle in a blind spot of the vehicle. To this end, in operation, the SOD system 14 forms detection zone 24 and SOD system 15 forms a detection zone 25.

Upon detection of an object (e.g., another vehicle) in the detection zone 24, the SOD system 14 sends an alert signal indicating the presence of an object to either or both of the alert displays 82, 84 through the CAN bus 66. In response to receiving the alert signal, the displays provide an indicator (e.g., a visual, audio, or mechanical indicator) which indicate the presence of an object. Similarly, upon detection of an object in the detection zone 25 SOD system 15 sends an alert signal indicating the presence of another vehicle to one or both of alert displays 82, 86 through the CAN bus 66. However, in an alternate embodiment, the SOD system 14 may communicate the alert signal to the alert display 82 through a human/machine interface (HMI) bus 68. Similarly, SOD system 15 may communicate the alert signal to the other alert display 86 through another human/machine interface (HMI) bus 70.

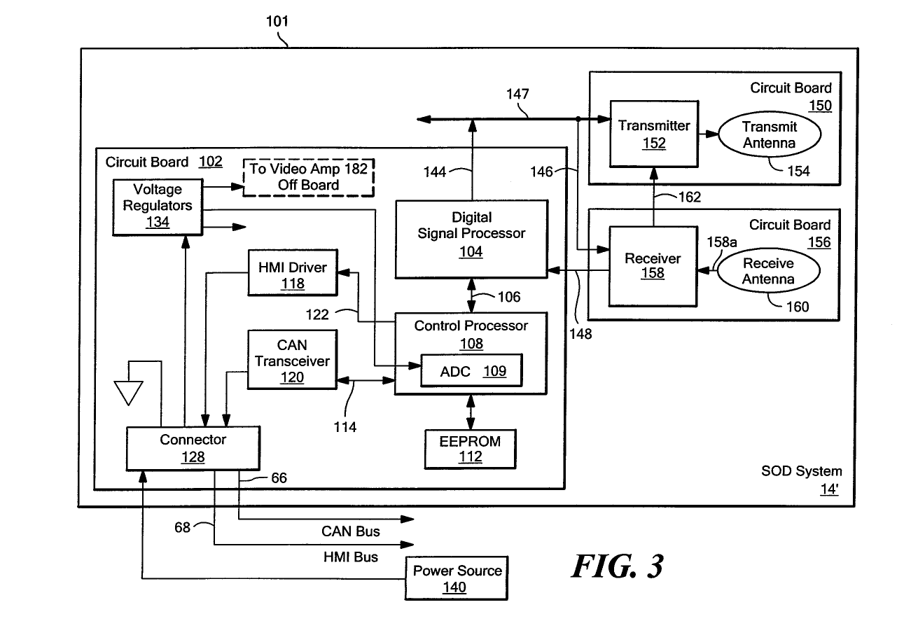

Referring to FIG. 3, an SOD system 14′ which may be the same as or similar to SOD 14 described above in conjunction with FIGS. 1 and 2, includes a housing 101, in which a fiberglass circuit board 102, a polytetrafluoroethylene (PTFE) circuit board 150, and a low temperature co-fired ceramic (LTCC) circuit board 156 reside. In other embodiments, circuit board 150 may be a LTCC. In other embodiments, circuit board 150 may be a hydrocarbon material.

The fiberglass circuit board 102 has disposed thereon a digital signal processor (DSP) 104 coupled to a control processor 108. In general, the DSP 104 is adapted to perform signal processing functions, for example, fast Fourier transforms (FFTs). The control processor 108 is adapted to perform digital functions, for example, to identify conditions under which an operator of a vehicle on which the SOD system 14 is mounted should be alerted to the presence of another object such as a vehicle in a blind spot. The control processor 108 includes an analog-to-digital converter (ADC) 109. As will be described further below, ADC 109 may be used to detect interference signals in SOD system 14′.

The control processor 108 is coupled to an electrically erasable read-only memory (EEPROM) 112 adapted to retain a variety of values, for example, calibration values. Other read only memories associated with processor program memory are not shown for clarity. The control processor 108 is coupled to a CAN transceiver 120, which is adapted to communicate, via a connector 128, on the CAN bus 66.

The control processor 108 is coupled to an optional human/machine interface (HMI) driver 118, which may communicate via the connector 128 to the HMI bus 68. The HMI bus 68 may include any form of communication media and communication format, including, but not limited to, a fiber optic media with an Ethernet format, and a wire media with a two state format.

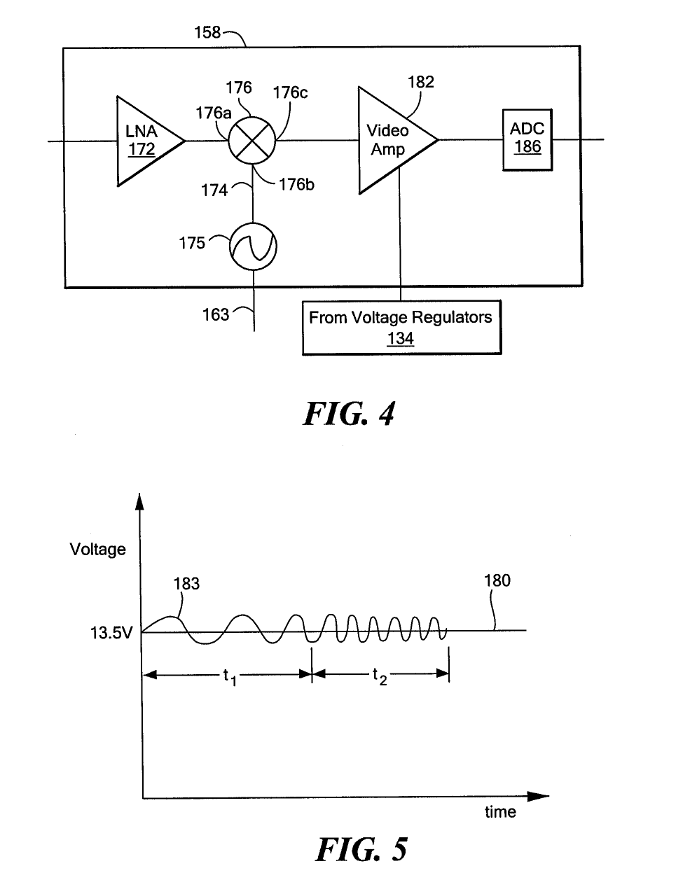

The fiberglass circuit board 102 receives a power signal from a power source 140 of vehicle 12. In one example, the power source 140 is a signal from an alternator (not shown) of the vehicle 12, for example, the alternator provides a DC signal (e.g., 13.5 Volts). In another example, the power source 140 is a transformer (e.g., an AC-DC transformer). Through the connector 128, the power signal may be coupled to one or more voltage regulators 134, which provide one or more respective regulated voltages to components of the SOD system 14. For example, the voltage regulators 134 condition a power signal from the power source 140 by reducing the magnitude of the voltage to a voltage level that will not damage components of SOD system 14. Components of SOD system 14 include but are limited to the electrical components described herein including amplifiers (e.g., a video amplifier 182 (see FIG. 4)), analog-to-digital converters (e.g., ADC 109), processors and so forth.

The PTFE circuit board 150 includes a radar transmitter 152, which is coupled to the DSP 104 through a serial port interface (SPI) 147 and a bus 144, and a transmit antenna 154, which is coupled to the radar transmitter 154.

The LTCC circuit board 156 includes a receiver 158, which is coupled to the DSP 104 through SPI 147 and a bus 146, and a receive antenna 160, which is coupled to the radar receiver 158. The radar transmitter 152 and the radar receiver 158 may receive the regulated voltages from the voltage regulator 134. The receiver 158 also provides RF signals to the transmitter 152 through a bus 162.

In operation, the DSP 104 generates one or more ramp signals 144, each having a respective start voltage and a respective end voltage. The ramp signals are fed to the transmitter 152. In response to the ramp signals, the transmitter 152 generates RF signals having waveform characteristics controlled by the ramp signal. The RF signals are coupled from the transmitter to the transmit antenna 154, where they are emitted (or radiated) as chirp radar signals. As used herein, the term “chirp” is used to describe a generally sinusoidal signal having a frequency that varies with time in a substantially continuous fashion during a time window, and which has a start frequency and an end frequency associated with each chirp. A chirp may be a linear chirp, for which the frequency varies in a substantially linear fashion between the start and end frequencies. A chirp may also be a non-linear chirp, in which the frequency varies in a substantially non-linear fashion between the start and end frequencies. A chirp radar signal is transmitted though wireless media, for example, through the air. A chirp signal or a chirp waveform is an electrical signal, which may be communicated via a wire media.

The transmit antenna 154 may transmit the chirp radar signals in one transmit beam or in more than one transmit beam. In either arrangement, the transmit antenna 154 transmits the chirp radar signal in an area generally encompassing the extent of a desired detection zone 24.

The receive antenna 160 may form more than one receive beam, for example, seven receive beams 22a-22g as shown in FIG. 1. Each of the receive beams receives received radar signals, or otherwise generates and/or receives noise radar signals. Signals associated with the receive beams are directed to the radar receiver 158. The radar receiver 158 may provide a variety of functions, including, but not limited to, amplification, mixing of received signals and/or noise signals with the chirp signal to provide a baseband signal, and analog to digital (ADC) conversion of the baseband signal, resulting in a converted signal being transmitted on a bus 148.

The converted signal has a frequency content, wherein different frequencies of peaks therein correspond to detected objects at different ranges. The above-described amplification of the receiver 158 may be a time-varying amplification, controlled, for example, by a control signal sent on a bus 146 by the DSP 104.

The DSP 104 analyzes the converted signals and identifies an object in the detection zone 24. In one particular embodiment, the DSP 104 performs a frequency domain conversion of the converted signals, for example, with an FFT performed in conjunction with each one of the receive beams.

Since an object detected in the converted signal 148 by the DSP 104 may be an object for which the operator of the first vehicle 12 has little concern and need not be alerted, for example, a stationary guard rail along the roadside, further criteria may be used to identify when an alert signal should be generated and sent to the operator. The control processor 108 receives object detections on a bus 106 from the DSP 104. The control processor 108 may use further criteria to control generation of an alert signal. For example, upon determination by the control processor 108, the alert signal may be generated and sent through a bus 114 to CAN transceiver 120 and communicated on the CAN bus 66, which is indicative not only of an object in the detection zone 24, but also is indicative of an object having predetermined characteristics being in the detection zone. In other embodiments, an alert signal may be communicated by control processor 108 on a bus 122 through the HMI driver 118 to the HMI bus 68.

The fiberglass circuit board 102, the PTFE circuit board 150, and the LTCC circuit board 156 are comprised of materials having known behaviors for signals within particular frequency ranges. It is known, for example, that fiberglass circuit boards have acceptable signal carrying performance at signal frequencies up to a few hundred MHz. LTCC circuit boards and PTFE circuit boards are know to have acceptable signal carrying performance at much higher frequencies. Thus, the lower frequency functions of the SOD system 14 are disposed on the fiberglass circuit board 102, while the functions having frequencies in the radar range of frequencies (e.g., 2 GHz) are disposed on the LTCC and on the PTFE circuit boards 150, 156, respectively.

Referring to FIG. 4, the receiver 158 includes an RF low-noise amplifier (LNA) 172, an oscillator 175, a mixer 176, a video amplifier 182 and an analog-to-digital converter (ADC) 186. An RF signal received through antenna 160 (FIG. 3) is provided to an input of the RF LNA 172. The LNA 172 provides an amplified version of the signal fed thereto to a first input port 176a of a mixer 176. The oscillator provides a local oscillator signal along signal path 174 to a second port 176b of the mixer 176. Illustrative frequencies for the RF signals from the amplifier 172 and the LO signal are on the order of 24 GHz. Although the exemplary receiver 158 is shown as a direct conversion, homodyne receiver, other receiver topologies may also be used in the SOD system 14. Mixer 176 receives the RF and LO signals provided thereto and provides a down-converted signal at a third port 176c.

The down-converted signal is fed from the third part 176c of the mixer 176 to an input port of a video amplifier 182 which amplifies and filters the down-converted signals. In the illustrative embodiment of FIG. 4, the down-converted signals are provided having a frequency between 1 kHz and 40 kHz.

The ADC converter 186 converts the analog output of the video amplifier 182 into digital signal samples for further processing. In particular, the digital signal samples are processed by a fast Fourier transform (FFT) within the DSP 104 in order to determine the content of the return signal within various frequency ranges.

Referring to FIGS. 4 and 5, typically when a power source (e.g., an alternator) fails, the voltage tends to modulate thereby mimicking a sine wave behavior. Over time, the frequency of the sine wave increases to a frequency that interferes with the functionality of SOD system 14. For example, the power source 140 (FIG. 3) is designed to provide a 13.5 Volt DC output signal, for example, as indicated by reference line 180; however, when the power source is not operating properly, the power source 140 provides a power signal 183 having a sine wave with a frequency which increases over time. For example, during a first period of time, t₁, the frequency of the power signal is fi, while in a second period of time, t₂, the frequency of the power signal is f₂, where f₂ is greater than f₁. If the frequency of the power signal 183 is within a particular frequency band, then the power signal provided to the amplifier 182 via the voltage regulators 134 (FIG. 3) may inject a signal into the receiver 158 through the video amplifier 182 and may cause the receiver 158 to falsely detect an object. For example, if the SOD system 14 detects objects in a frequency band (e.g., about 1 kHz to about 100 kHz) and the power source 140 generates a power signal having a frequency within the frequency band, then the SOD system 14 may falsely detect an object.

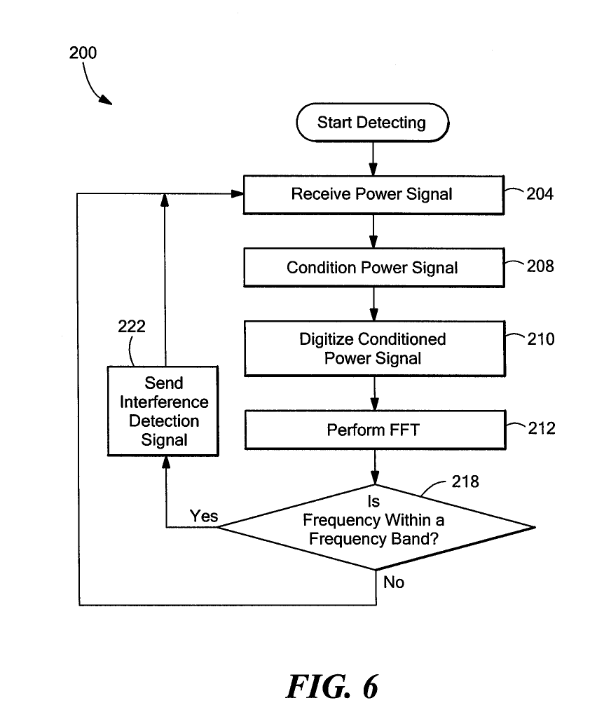

Referring to FIG. 6, process 200 is an exemplary process for detecting interference signals in a vehicle system, and in particular, interference signals caused by a power supply of a vehicle in which the vehicle radar system is disposed. Process 200 receives the power signal (204). Process 200 conditions the power signal (208). For example, voltage regulators 134 are used to condition the power signal. Process 200 digitizes the conditioned power signal (210). For example, ADC 109 converts the conditioned power signal from analog to digital components. Process 200 performs an FFT on the digitized and conditioned power signal (212). For example, control processor 108 performs the FFT. Process 200 determines whether the frequency of the power signal is within a frequency band (218). The frequency band is a frequency band which is a range of frequencies for which SOD system 14 detects objects. If the frequency is within the frequency band, then process 200 sends an interference detection signal (222). For example, processor 108 may send the interference detection signal to the HMI driver 118 through bus 122 to HMI bus 68 to warn the operator of vehicle 12 that SOD system 14 is malfunctioning. In another example, the interference detection signal may cause control processor 108 to disengage processing of received signals until the interference ceases. In a further example, processor 108 may send the interference detection signal on the bus 114 through the CAN transceiver to CAN bus 66.

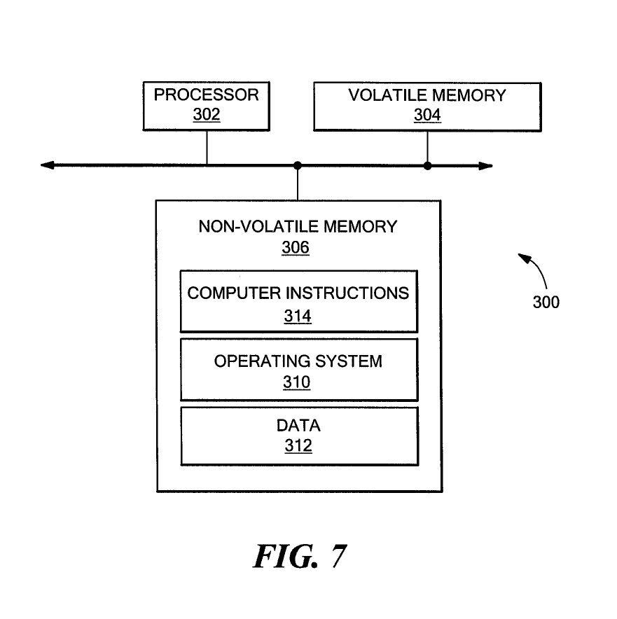

FIG. 7 shows a computer 300 using process 200. Computer 300 includes a processor 302, a volatile memory 304, a non-volatile memory 306 (e.g., hard disk). Non-volatile memory 306 stores operating system 310, data 312 and computer instructions 314, which are executed by processor 302 out of memory 304 to perform process 200.

Process 200 is not limited to use with the hardware and software of FIG. 7; it may find applicability in any computing or processing environment and with any type of machine that is capable of running a computer program. Process 200 may be implemented in hardware, software, or a combination of the two. Process 200 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 200 and to generate output information.

The system may be implemented, at least in part, via a computer program product (i.e., a computer program tangibly embodied in an information carrier (e.g., in a machine-readable storage device or in a propagated signal, for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform process 200. Process 200 may also be implemented as a machine-readable storage medium, configured with a computer program, where upon execution, instructions in the computer program cause the computer to operate in accordance with process 200.

The processes described herein are not limited to the specific embodiments described herein. For example, the processes are not limited to the specific processing order of FIG. 6. Rather, any of the blocks of FIG. 6 may be re-ordered, repeated, combined or removed, performed in parallel or in series, as necessary, to achieve the results set forth above.

While two SOD systems 14, 15 are shown in FIGS. 1 and 2, the system 50 may include any number of SOD systems, including a single SOD system. While the alert displays 82, 86 are shown to be associated with side-view mirrors, the alert displays may be provided in a variety of ways. For example, in other embodiments, the alert displays may be associated with a rear view mirror (not shown). In other embodiments, the alert displays are audible alert displays.

While the CAN bus 66 is shown and described, it will be appreciated that the SOD systems 14, 15 may couple through any of a variety of other busses within the vehicle 12, including, but not limited to, an Ethernet bus, and a custom bus.

The system described herein is not limited to use with the hardware and software described above. The system may be implemented in digital electronic circuitry, or in computer hardware, firmware, software, or in combinations thereof.

While three circuit boards 102, 150, 156 are described, the SOD system 14 may be provided on more than three or fewer than three circuit boards. Also, the three circuit boards 102, 150, 156 may be comprised of other materials than those shown in FIG. 2.

Method steps associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data.

The system is not limited to the specific examples described herein. For example, while the system described herein is within a vehicle radar system, the system may be used in any vehicle system requiring the evaluation of power supply interference. While fast Fourier transforms (FFTs) are described below, which perform a conversion of time domain signals to the frequency domain, a variety of other transforms may be used, for example, discrete Fourier transforms (DFTs).

Elements of different embodiments described herein may be combined to form other embodiments not specifically set forth above. Other embodiments not specifically described herein are also within the scope of the following claims.

What is claimed is:

1. A method, comprising:
detecting interference in a vehicle system disposed in a vehicle, detecting comprising:
measuring a frequency of a signal provided from a power source used in the vehicle; and
determining if the signal has a frequency within a frequency band used by the vehicle system.

2. The method of claim 1 wherein measuring the frequency of the signal comprises measuring the frequency of the signal from a power source providing power to a component of the vehicle system.

3. The method of claim 1, further comprising sending an interference detection signal in response to the signal being within the frequency band.

4. The method of claim 3 wherein sending the interference detection signal comprises sending the interference detection signal to a human/machine interface.

5. The method of claim 3 wherein sending the interference detection signal comprises sending the interference detection signal to the vehicle system.

6. The method of claim 1 wherein detecting comprises performing a fast Fourier transform (FFT) on the signal.

7. The method of claim 6, further comprising converting the signal to digital samples.

8. The method of claim 1 wherein measuring the signal from the power source comprises conditioning the signal.

9. The method of claim 1 wherein detecting interference in a vehicle comprises detecting interference in a vehicle radar system.

10. The method of claim 9 wherein determining if the signal has the frequency within the frequency band used by the vehicle system comprises determining if the signal has a frequency band from about 1 kHz to about 100 kHz used by the vehicle radar system to detect objects.

11. The method of claim 9 wherein measuring the frequency of the signal comprises measuring a frequency of a signal provided from an alternator.

12. An article comprising a machine-readable medium that stores executable instructions, the instructions causing a machine to:
detect interference in a vehicle system, the instructions causing a machine to detect comprising instructions causing a machine to:
measure a frequency of a signal provided from a power source providing power to a component of the vehicle system; and
determine if the signal has a frequency within a frequency band used by the vehicle system.

13. The article of claim 12, further comprising instructions causing the machine to send an interference detection signal in response to the frequency being within the frequency band.

14. The article of claim 13 wherein the instructions causing the machine to send the interference detection signal comprises instructions causing the machine to send the interference detection signal to the vehicle system.

15. The article of claim 12 wherein the instructions causing the machine to detect comprises instructions causing the machine to perform a fast Fourier transform (FFT) on the signal.

16. The article of claim 15, further comprising instructions causing the machine to convert the signal to digital samples.

17. The article of claim 12 wherein the instructions causing the machine to detect interference comprises instructions causing the machine to detect interference in a vehicle radar system,
wherein the instructions causing the machine to determine if the signal has the frequency within a frequency band used by the vehicle system comprises instructions causing the machine to determine if the signal has a frequency band from about 1 kHz to about 100 kHz used by the vehicle radar system to detect objects.

18. (canceled)

19. The article of claim 17 wherein the instructions causing the machine to measure a frequency of the signal comprises instructions causing the machine to measure a frequency of a signal provided from an alternator.

20. An apparatus, comprising:
circuitry to detect interference in a vehicle system, the circuitry to detect comprising circuitry to:
measure a frequency of a signal provided from a power source providing power to a component of the vehicle system; and
determine if the signal has a frequency within a frequency band used by the vehicle system.

21. The apparatus of claim 20 wherein the circuitry comprises at least one of a processor, a memory, programmable logic or logic gates.

22. The apparatus of claim 20, further comprising circuitry to send an interference detection signal in response to the signal being in the frequency band

23. The apparatus of claim 22 wherein the circuitry to send the interference detection signal comprises circuitry to send the interference detection signal to the vehicle system.

24. The apparatus of claim 20 wherein the circuitry to detect comprises circuitry to perform a fast Fourier transform (FFT) on the signal.

25. The apparatus of claim 24, further comprising circuitry to convert the signal to digital samples.

26. The apparatus of claim 20 wherein the circuitry to detect comprises circuitry to detect interference in a vehicle radar system,
wherein the circuitry to determine if the signal has a frequency within a frequency band used by the vehicle system comprises circuitry to determine if the signal has a frequency band from about 1 kHz to about 100 kHz used by the vehicle radar system to detect objects,
wherein the circuitry to measure the frequency of the signal comprises circuitry to measure a frequency of a signal provided from an alternator.

27-28. (canceled)
